(19) United States
(12) Patent Application Publication
(10) Pub. No.: US 2013/0326515 A1
(43) Pub. Date: Dec. 5, 2013

(54) DEVICE, RECORDING MEDIUM, AND METHOD

(71) Applicant: FUJITSU LIMITED, Kawasaki-shi (JP)

(72) Inventors: Yusuke HARA, Kawasaki (JP); Makoto KOZAWA, Yokohama (JP); Futoshi WATANABE, Kawasaki (JP); Hiroshi TAKAMURE, Numazu (JP); Yoshitaka KIZUKA, Fuji (JP)

(73) Assignee: FUJITSU LIMITED, Kawasaki-shi (JP)

(21) Appl. No.: 13/845,771

(22) Filed: Mar. 18, 2013

(30) Foreign Application Priority Data
May 31, 2012 (JP) 2012-125034

(51) Int. Cl. G06F 9/455

(52) U.S. Cl. CPC G06F 9/455
USPC 718/1

(57) ABSTRACT

A device includes a memory which stores a program, and a processor which executes, based on the program, a procedure comprising deciding, based on maximum bandwidth information included in bandwidth setting information corresponding to a network device existing on a route between a physical server serving as an allocation destination candidate of a virtual machine and a gateway, maximum bandwidth information of the virtual machine, available bandwidth information of the network device, and hardware resource information of the physical server, and instructing a decided physical server to create the virtual machine.

### CROSS-REFERENCE TO RELATED APPLICATION

This application is based upon and claims the benefit of priority of the prior Japanese Patent Application No. 2012-125034, filed on May 31, 2012, the entire contents of which are incorporated herein by reference.

### FIELD

The embodiment discussed herein is related to a device, a recoding medium, and a method.

### BACKGROUND

For example, with network systems which provide cloud service such as IaaS (Infrastructure as a Service) or the like, service has been provided to users by operating multiple virtual machines (VM) in a physical server using virtualization technology.

In the event of allocating a virtual machine in a network system including multiple physical servers, a physical server where a virtual machines is allocated has been decided based on a hardware resource situation of each physical server.

Japanese Laid-open Patent Publication Nos. 2002-374286 and 2001-223741 and Japanese National Publication of International Patent Application No. 2009-537894 are examples of the related art of the present technology.

### SUMMARY

According to an aspect of the invention, a device includes a memory which stores a program, and a processor which executes, based on the program, a procedure comprising deciding, based on maximum bandwidth information included in bandwidth setting information corresponding to a network device existing on a route between a physical server serving as an allocation destination candidate of a virtual machine and a gateway, maximum bandwidth information of the virtual machine, available bandwidth information of the network device, and hardware resource information of the physical server, and instructing a decided physical server to create the virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating configurations of a network system and virtual machine management device according to the present embodiment;

FIG. 2 is a block diagram illustrating a hardware configuration of the virtual machine management device according to the present embodiment;

FIG. 3 is a flowchart illustrating processing at the time of allocation of a new virtual machine in the virtual machine device, virtual machine management program, and virtual machine management method according to the present embodiment;

FIG. 4 is a flowchart illustrating processing for narrowing down candidates serving virtual machine allocation destinations based on network bandwidth information included in processing at the time of allocation of a new virtual machine in the virtual machine device, virtual machine management program, and virtual machine management method according to the present embodiment;

FIG. 5 is a flowchart illustrating QoS setting change processing to be executed for each time flame in the virtual machine device, virtual machine management program, and virtual machine management method according to the present embodiment;

FIG. 6 is a diagram indicating SLA information (data) of each virtual machine, to be stored in the virtual machine management device according to the present embodiment;

FIG. 7 is a diagram indicating route information (data) between each physical server and a gateway, to be stored in the virtual machine management device according to the present embodiment;

FIG. 8 is a diagram indicating available maximum bandwidth information (capacity information; data) of each network device, to be stored in the virtual machine management device according to the present embodiment;

FIG. 9 is a diagram indicating QoS setting information (data) corresponding to each network device before allocation of a second virtual machine, to be stored in the virtual machine management device according to the present embodiment; and

FIG. 10 is a diagram indicating QoS setting information (data) corresponding to each network device after allocation of a second virtual machine, to be stored in the virtual machine management device according to the present embodiment.

### DESCRIPTION OF EMBODIMENT

In the event of having allocated a virtual machine in a network system including multiple physical servers, when deciding a physical server where the virtual machine is allocated without considering a network bandwidth used for the virtual machine to be allocated, as a result of allocating the new virtual machine in one physical server, and the network is in an unstable state, which may be detrimental to service responsiveness. For example, in the event that large volume of data with high priority which has been transmitted from multiple virtual machines allocated in one physical server is simultaneously transmitted to the network, processing load for a network device existing on the route thereof increases, and the network becomes unstable, which may be detrimental to service responsiveness. In this case, allocating a new virtual machine in another physical server may reduce such situations. That is to say, if resources in the network, i.e., network devices provided to the network are not effectively utilized, network bandwidths are not effectively be used.

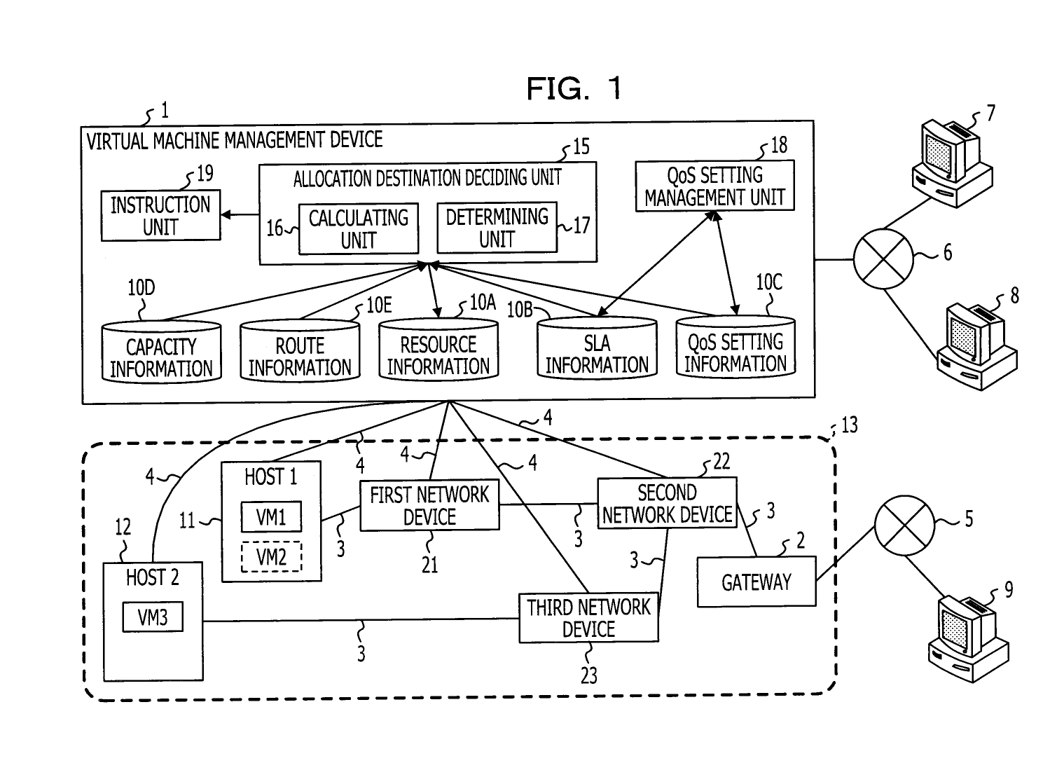

Hereinafter, description will be made regarding a virtual machine management device, virtual machine management program, virtual machine management method, and network system according to an embodiment of the present technology, with reference to FIGS. 1 to 10. The network system according to the present embodiment is a network system configured to provide cloud service, for example, such as the IaaS or the like. This network system is configured to provide service to users by operating multiple virtual machines VM in a physical server. Note that the network system will also be referred to as a cloud system or cloud environment.

Note that a user of service will be referred to as a service user. Also, a provider of service will be referred to a service provider. The service provider is a user of the system, and accordingly, also referred to as a system user, server user or tenant manager. Also, a manger of the system will be referred to as a system administrator. Here, the system administrator is an administrator for a cloud environment.

The present network system includes, as illustrated in FIG. 1, multiple physical servers 11 and 12, a gateway 2, multiple network devices 21 to 23, and a virtual machine management device 1.

Here, each of the multiple physical servers 11 and 12 is configured so as to operate one or more virtual machines. For example, with the multiple physical servers 11 and 12, a VM host serving as an OS (Operating System) for operating a virtual machine is implemented into each thereof, and accordingly, one or more VM guests may be operated. Here, the VM guests include a guest OS and application to be operated on a VM host. Here, there are provided two physical servers (VM hosts) of a first physical server 11 (VM host 1) and a second physical server 12 (VM host 2). Also, in a state in which a first virtual machine (first VM guest) VM1 is allocated in the first physical server 11, and a third virtual machine (third VM guest) VM3 is allocated in a second physical server 12, a second virtual machine (second VM guest) VM2 will be newly allocated as will be described later.

The multiple network devices 21 to 23 are provided onto each route between the multiple physical servers 11 and 12 and the gate way 2. These network devices 21 to 23 are network devices to which QoS (Quality of Service) may be set, and are a router, a switch, a firewall, and so forth, for example. Here, three network devices of the first network device 21, second network device 22, and third network device 23 are provided. Also, the first network device 21 is provided onto a route between the first physical server 11 and the gateway 2. Also, the second network device 22 is provided onto a route between the first physical server 11 and the gate way 2, and a route between the second physical server 12 and the gate way 2. Also, the third network device 23 is provided onto a route between the second physical server 12 and the gateway 2. In this manner, the first network device 21 and second network device 22 are provided onto the route between the first physical server 11 and the gateway 2. Also, the third network device 23 and second network device 22 are provided onto the route between the second physical server 12 and the gateway 2.

The virtual machine management device 1 is a server configured to manage a virtual machine to be allocated in the multiple physical servers 11 and 12. Here, the virtual machine management device 1 is also configured to perform management of the multiple network devices 21 to 23. Note that the virtual machine management device 1 will also be referred to as a virtual machine management server or management server. Also, a detailed configuration of the virtual machine management device 1 will be described later.

These physical servers 11 and 12, network devices 21 to 23, and gateway 2 are coupled via a network 3, for example, such as a LAN (Local Area Network) or the like. Also, the physical servers 11 and 12 and the network devices 21 to 23 are coupled to the virtual machine management device 1 via a network 4, for example, such as a LAN (Local Area Network) or the like, and serve as objects to be managed by the virtual machine management device 1. Therefore, the network 3 coupled to these physical servers 11 and 12 and network devices 21 to 23, i.e., the network 3 including the physical servers 11 and 12, the network devices 21 to 23 and gateway 2 is a network managed by the virtual machine management device 1. This area will also be referred to as a management area.

Also, the physical servers 11 and 12 are coupled to a network 5, for example, such as the Internet or the like via the network devices 21 to 23 and gateway 2. Here, the first physical server 11 is coupled to the network 5 via the first network device 21, second network device 22, and gateway 2. Consequently, the virtual machines (here, the first virtual machine VM1 and second virtual machine VM2) allocated in the first physical server 11 perform communication via the first network device 21, second network device 22, and gateway 2. Also, the second physical server 12 is coupled to the network 5 via the third network device 23, second network device 22, and gateway 2. Consequently, the virtual machine (here, the third virtual machine VM3) allocated in the second physical server 12 perform communication via the third network device 23, second network device 22, and gateway 2.

Also, the virtual machine management device 1 is coupled to the system administrator's terminal (computer) 7 and a system user's terminal 8 via a network 6, for example, such as the Internet or the like. Thus, the system administrator and system user are allowed to access the virtual machine management device 1 via the network 6 using these terminals 7 and 8.

Also, the physical servers 11 and 12 are coupled to a service user's terminal 9 via the network devices 21 to 23, gateway 2, and the network 5, for example, such as the Internet or the like. Thus, the service user is allowed to receive providing of service via the network 5 using this terminal 9.

Next, the virtual machine management device 1 according to the present embodiment will for example be described.

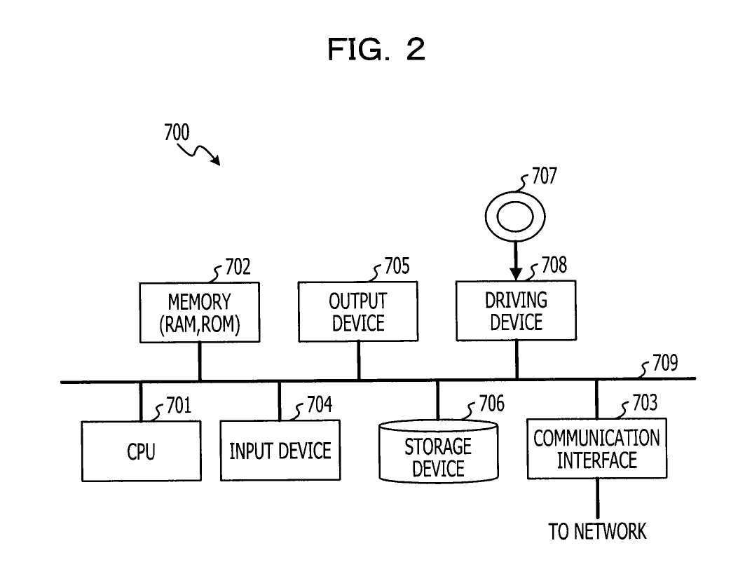

First, a hardware configuration of the present virtual machine management device 1 will be described with reference to FIG. 2.

The virtual machine management device 1 may be realized, for example, with a computer 700 such as a sever or the like, and a hardware configuration thereof includes, as illustrated in FIG. 2 for example, a CPU (Central Processing Unit) 701, memory 702, communication interface 703, input device 704, output device 705, storage device 706, and driving device 708 of a portable recording medium 707, and is configured so that these are mutually coupled by a bus 709. Note that the hardware configuration of the present device is not restricted to this.

Here, the CPU 701 controls the entire computer, and reads out a program to the memory 702, and executes the program to perform processing used for management of virtual machines and network devices.

The memory 702 is, for example, RAM, and temporarily stores a program or data at the time of execution of a program, rewriting of data, or the like.

The communication interface 703 is employed for communicating with another device via a network, for example, such as a LAN or the Internet or the like. This communication interface 703 may originally be included in the computer 700, or may be an NIC (Network Interface Card) retrofitted to the computer 700.

The input device 704 is a pointing device or keyboard, for example, such as a mouse or the like.

The output device 705 is a display device, for example, such as a liquid crystal display or the like. Note that these input device 704 and output device 705 may be an input device and an output device included in another computer coupled to the network.

The storage device 706 is, for example, a hard disk drive, in which a later-described virtual machine management program and various types of data are stored. Note that, for example, ROM (Read Only Memory) may be provided as the memory 702 in which a later-described virtual machine management program and various types of data are stored.

The driving device 708 is to access the stored contents of the portable recording medium 707, for example, such as an optical disc, magneto-optical disk, or the like.

With the computer 700 having such a hardware configuration, for example, the CPU 701 reads out a virtual machine management program stored in the storage device 706 to the memory 702, and executes the program, and accordingly, the present virtual machine management device, i.e., various functions for allocating a new virtual machine of the present virtual machine management device are realized. Note that the virtual machine management program will also be referred to as a manager, VM manager, or management software. Also, this virtual machine management program is included in cloud construction software, i.e., IaaS construction software.

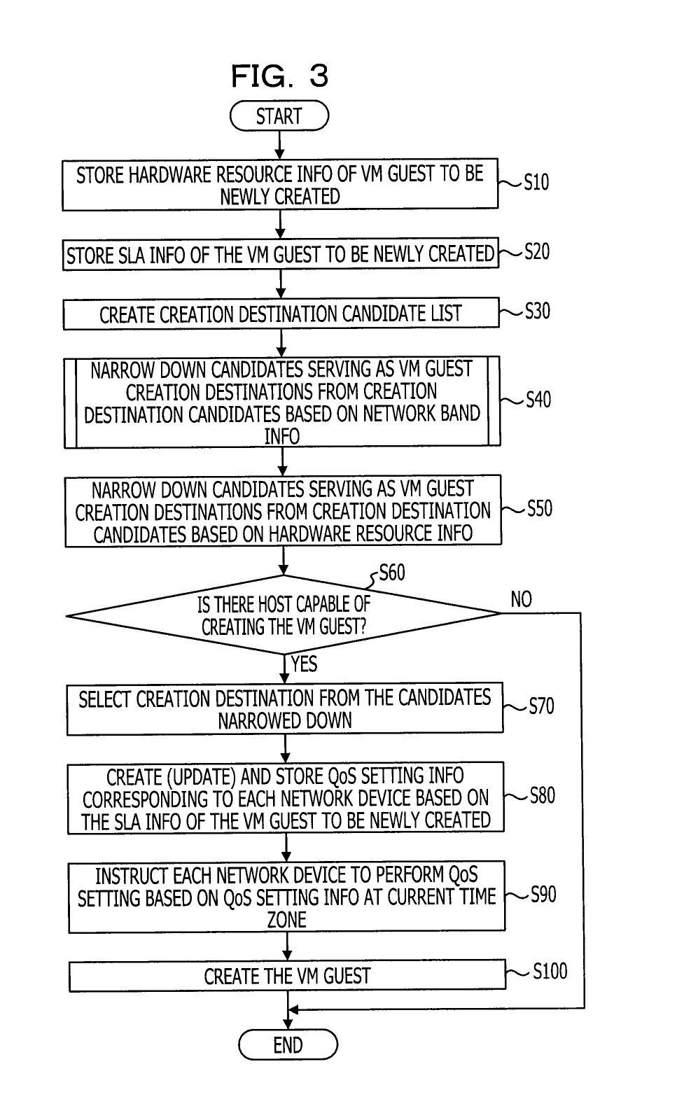

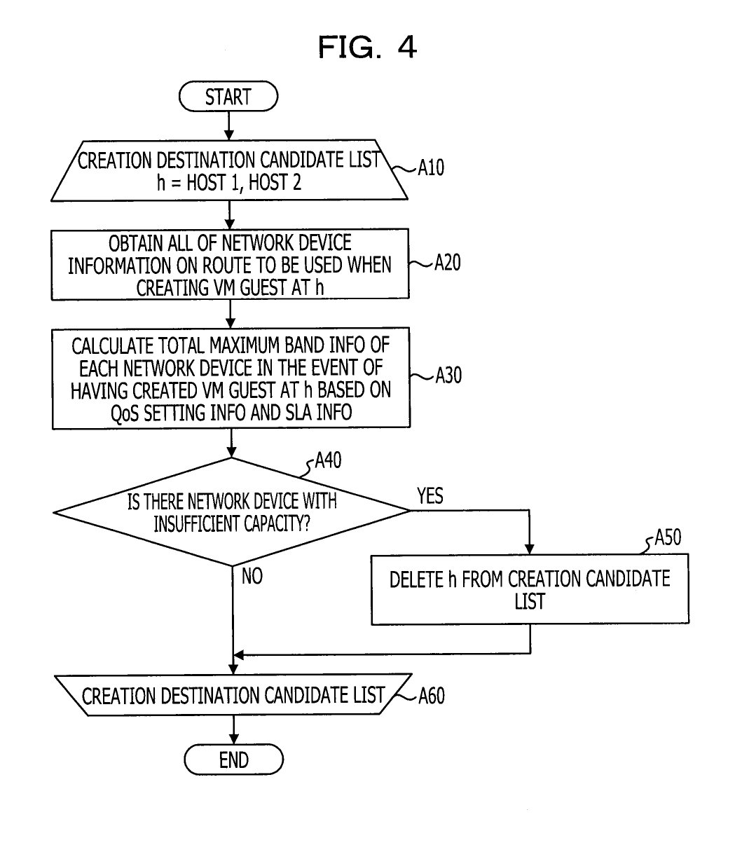

Next, with the present virtual machine management device 1, processing that the CPU 701 executes in accordance with the virtual machine management program read in the memory 702 (virtual machine management method), i.e., processing for allocating a new virtual machine will be described with reference to FIGS. 3 and 4.

Now, description will be made regarding a case where in a state in which the first virtual machine VM1 is allocated in the first physical server 11, and the third virtual machine VM3 is allocated in the second physical server 12, the second virtual machine VM2 is to be newly allocated, as an example. In this case, the system user (or system administrator) accesses the virtual machine 1 via the network 6 using the terminal 8 (or 7) to instruct execution of the virtual machine management program, i.e., execution of processing for newly allocating a virtual machine (processing for newly creating a VM guest).

First, as illustrated in FIG. 3, the virtual machine management device 1 obtains hardware resource information such as the CPU, memory, HDD (Hard Disk Drive) and so forth of a virtual machine to be newly allocated (here, second virtual machine VM2), and stores this in the storage device 706 (step S10). For example, the virtual machine management device 1 displays a screen for inputting the hardware resource information such as the CPU, memory, HDD, and so forth of the second virtual machine VM2 on the display device of the terminal 8 (or 7) of the system user (or system administrator). In response to this, upon the system user (or system administrator) having used the input device of the terminal 8 (or 7) to input hardware resource information such as the CPU, memory, HDD, and so forth of the second virtual machine VM2, the hardware resource information is transmitted to the virtual machine management device 1. In this manner, the virtual machine management device 1 obtains hardware resource information such as the CPU, memory, HDD, and so forth of the second virtual machine VM2, and stores this in the storage device 706. Consequently, the storage device 706 includes a virtual machine resource information storage unit (virtual machine resource information database) 10A in which the hardware resource information of virtual machines are stored (see FIG. 1).

Next, the virtual machine management device 1 obtains SLA (Service Level Agreement) information of a virtual machine to be newly allocated (here, the second virtual machine VM2), and stores this in the storage device 706 (step S20). For example, The virtual machine management device 1 displays a screen for inputting the SLA information of the second virtual machine VM2 on the display device of the terminal 8 (or 7) of the system user (or system administrator). In response to this, upon the system user (or system administrator) having used the input device of the terminal 8 (or 7) to input the SLA information of the second virtual machine VM2, the SLA information is transmitted to the virtual machine management device 1. In this manner, the virtual machine management device 1 obtains the SLA information of the second virtual machine VM2. The virtual machine management device 1 then stores the obtained SLA information of the second virtual machine VM2 in the storage device 706. Note that the SLA will also be referred to as network SLA.

Here, the SLA information includes minimum bandwidth information and maximum bandwidth information for each time flame. Note that the minimum bandwidth information is a value representing a bandwidth to be guaranteed at the minimum, and the maximum bandwidth information is a value representing not to use a bandwidth equal to or greater than this value. Also, here, the first virtual machine VM1 and third virtual machine VM3 have already been created, and at the time of creating these virtual machines VM1 and VM3, the SLA information of these virtual machines VM1 and VM3 are stored in the storage device 706. Consequently, the storage device 706 stores the SLA information of the virtual machines VM1 to VM3. That is to say, the storage device 706 includes an SLA information storage unit (SLA information database) 10B in which SLA information are stored (see FIG. 1).

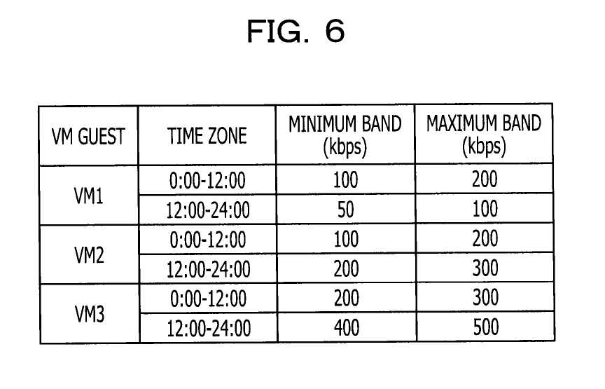

With the present embodiment, the minimum bandwidth information and maximum bandwidth information included in the SLA information of the virtual machines VM1 to VM3 are stored in the storage device 706 for each time flame. That is to say, values of 100 kbps and 200 kbps are, as illustrated in FIG. 6, stored in the storage device 706, i.e., the SLA information storage unit 10B as the minimum bandwidth information and maximum bandwidth information of a time flame of 0:00 to 12:00 of the first virtual machine VM1, respectively. Also, values of 50 kbps and 100 kbps are stored as the minimum bandwidth information and maximum bandwidth information of a time flame of 12:00 to 24:00 of the first virtual machine VM1, respectively. Also, values of 100 kbps and 200 kbps are stored as the minimum bandwidth information and maximum bandwidth information of a time flame of 0:00 to 12:00 of the second virtual machine VM2, respectively. Also, values of 200 kbps and 300 kbps are stored as the minimum bandwidth information and maximum bandwidth information of a time flame of 12:00 to 24:00 of the second virtual machine VM2, respectively. Also, values of 200 kbps and 300 kbps are stored as the minimum bandwidth information and maximum bandwidth information of a time flame of 0:00 to 12:00 of the third virtual machine VM3, respectively. Also, values of 400 kbps and 500 kbps are stored as the minimum bandwidth information and maximum bandwidth information of a time flame of 12:00 to 24:00 of the third virtual machine VM3, respectively.

Next, the virtual machine management device 1 extracts a physical server serving as an allocation destination candidate of a virtual machine to be newly allocated (here, the second virtual machine VM2) to create an allocation destination candidate list (step S30). That is to say, the virtual machine management device 1 extracts a VM host serving as a creation destination candidate of a VM guest to create a creation destination candidate list. For example, in the event that an available physical server has been determined for each system user, a system user who attempts to allocate the second virtual machine VM2 this time creates a list of available physical servers (VM hosts). Here, the first physical server 11 and second physical server 12 are extracted as physical servers serving as allocation destination candidates of the second virtual machine VM2, and an allocation destination candidate list is created. That is to say, here, the VM host 1 and VM host 2 are extracted as VM hosts serving as creation destination candidates of VM guests, and a creation destination candidate list is created.

Next, the virtual machine management device 1 decides a physical server serving as an allocation destination of a virtual machine to be newly allocated (here, the second virtual machine VM2) out of the physical server allocation destination candidate list (steps S40 to S70). That is to say, the virtual machine management device 1 decides a VM host serving as a creation destination of a VM guest out of the VM host creation destination candidate list.

Here, the virtual machine management device 1 decides a physical server serving as an allocation destination of a virtual machine (here, the second virtual machine VM2), i.e., a VM host serving as a VM host creation destination, based on network bandwidth information and hardware resource information of the physical servers 11 and 12. For example, the virtual machine management device 1 decides a physical server where a virtual machine is allocated, based on the maximum bandwidth information included in the bandwidth setting information for the network devices 21 to 23 existing on the routes between the allocation candidate physical servers 11 and 12, and the gateway 2 which are virtual machine allocation destination candidates, the maximum bandwidth information of a virtual machine of which the allocation destination is to be decided (here, the second virtual machine VM2), the available maximum bandwidth information of the network devices 21 to 23, and the hardware resource information of the physical servers 11 and 12. In this manner, in the event of having allocated a new virtual machine (VM guest) in a situation in which the multiple physical servers 11 and 12 (VM hosts) serve as objects to be managed, the virtual machine management device 1 decides a physical server where the virtual machine is allocated by considering not only the hardware resource situations of the physical servers 11 and 12 but also a network bandwidth situation (network load). Note that the available maximum bandwidth information will also be referred to as available bandwidth information.

Consequently, the virtual machine management device 1 has a function to decide a physical server where a virtual machine is allocated (deciding unit 15) based on the maximum bandwidth information included in the bandwidth setting information corresponding to network devices existing on a route between a physical server serving as a virtual machine allocation destination candidate and the gateway, the maximum bandwidth information of a virtual machine of which the allocation destination is to be decided, the available maximum bandwidth information of network devices, and the hardware resource information of physical servers (see FIG. 1). Note that the deciding unit 15 will also be referred to as an allocation destination deciding unit.

With the present embodiment, first, the virtual machine management device 1 narrows down the physical servers (VM hosts) serving as allocation destination candidates out of the allocation destination candidate list based on the network bandwidth information (step S40).

For example, the virtual machine management device 1 narrows down the physical servers serving as allocation destination candidates based on the maximum bandwidth information included in the QoS setting information corresponding to the network devices 21 to 23 existing on the routes between the physical servers 11 and 12 serving as allocation destination candidates and the gateway 2, the maximum bandwidth information of the virtual machine of which the allocation destination is to be decided (here, the second virtual machine VM2), and the available maximum bandwidth information of the network devices 21 to 23.

Here, the QoS setting information includes the minimum bandwidth information and maximum bandwidth information. Here, the QoS setting information includes the minimum bandwidth information and maximum bandwidth information for each time flame. Note that the minimum bandwidth information is the smallest value guaranteed, and the maximum bandwidth information is a value representing not to use a bandwidth equal to or greater than this value. Also, the QoS setting information is managed by the virtual machine management device 1. Consequently, the virtual machine management device 1 has a function to manage the QoS setting information of a network device (QoS setting management unit 18) (see FIG. 1).

Note that the maximum bandwidth information and maximum bandwidth information included in the QoS setting information will also be referred to as bandwidth setting information. Also, the QoS setting information will also be referred to as network quality information, or motion stipulating information for stipulating the motion of a network device. Also, the maximum bandwidth information of a virtual machine of which the allocation destination is to be decided is included in the SLA information of the virtual machine. Here, the virtual machine of which the allocation destination is to be decided is the second virtual machine VM2, and accordingly, the maximum bandwidth information is the maximum bandwidth information included in the SLA information of the second virtual machine VM2. Also, the available maximum bandwidth information of the network devices 21 to 23 will also be referred to as capacity information of the network devices 21 to 23.

Hereinafter, description will be made regarding processing for narrowing down physical servers (VM hosts) serving as allocation destination candidates out of the allocation destination candidate list based on this network bandwidth information, with reference to FIG. 4.

Note that the processing illustrated in FIG. 4 is repeatedly performed for each physical server included in the physical server allocation candidate list. Here, the first physical server 11 and second physical server 12 are included in the allocation destination candidate list, and accordingly, the processing illustrated in FIG. 4 is performed for the first physical server 11, and the processing illustrated in FIG. 4 is then performed for the second physical server 12. That is to say, the VM hosts 1 and 2 are included in the creation destination candidate list, and accordingly, the processing illustrated in FIG. 4 is performed for the VM host 1, and then the processing illustrated in FIG. 4 is performed for the VM host 2.

First, the virtual machine management device 1 selects the first physical server 11 (VM host 1) included in the allocation destination candidate list (h=VM host 1), and starts repeat processing, i.e., processing in steps A10 to A60 in FIG. 4 (step A10).

That is to say, first, the virtual machine management device 1 obtains, in the event that the virtual machine (here, the second virtual machine VM2; VM guest) is allocated in the physical server 11, network device information existing on the route with the gateway 2 (step A20).

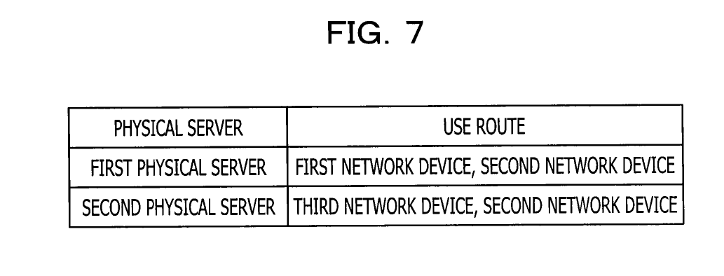

With the present embodiment, let us say that network device information existing on each of the routes between the physical servers 11 and 12 serving as objects to be managed and the gate way 2 is stored in the storage device 706. Here, the first physical server 11 and second physical server 12 are provided as physical servers to be managed. Therefore, let us say that the first network device 21 and second network device 22 are, as illustrated in FIG. 7, stored in the storage device 706 as a table in a manner correlated with the first physical server 11 as network device information existing on the route between the first physical server 11 and the gateway 2. Also, let us say that the third network device 23 and second network device 22 are, as illustrated in FIG. 7, stored in the storage device 706 as a table in a manner correlated with the second physical server 12 as network device information existing on the route between the second physical server 12 and the gateway 2. In this manner, network device information existing on each of the routes between each physical server and the gateway, i.e., route information is stored in the storage device 706. That is to say, the storage device 706 includes a route information storage unit (route information database) 10E in which network device information existing on each of the routes between each physical server and the gateway, i.e., route information are stored (see FIG. 1).

Therefore, with the present embodiment, the virtual machine management device 1 references the table stored in the storage device 706 to obtain the first network device 21 and second network device 22 as network device information existing on the route with the gateway 2 in the event of having allocated the second virtual machine VM2 in the first physical server 11.

Next, the virtual machine management device 1 calculates total maximum bandwidth information of the first network device 21 and second network device 22 in the event of having allocated the virtual machine (here, the second virtual machine VM2; VM guest) in the first physical server 11 (step A30). Consequently, the virtual machine management device 1 has a function to calculate total maximum bandwidth information of network devices in the event of having allocated a virtual machine in a physical server (calculating unit 16) (see FIG. 1). This calculating unit 16 is included in the above-mentioned deciding unit 15.

With the present embodiment, the virtual machine management device 1 calculates total maximum bandwidth information of the first network device 21 in the event of having allocated the second virtual machine VM2 in the first physical server 11 based on the maximum bandwidth information included in the QoS setting information corresponding to the first network device 21, and the maximum bandwidth information of the second virtual machine VM2. That is to say, the virtual machine management device 1 reads out the maximum bandwidth information of the second virtual machine VM2 from the storage device 706, i.e., the SLA information storage unit 10B. Also, the virtual machine management device 1 reads out the maximum bandwidth information included in the QoS setting information corresponding to the first network device 21 from a QoS setting information storage unit 10C. The virtual machine management device 1 then calculates total maximum bandwidth information of the first network device 21 in the event of having allocated the second virtual machine VM2 in the first physical server 11 by adding the maximum bandwidth information of the second virtual machine VM2 to the maximum bandwidth information included in this QoS setting information.

Consequently, the virtual machine management device 1 has a function to calculate total maximum bandwidth information of network devices in the event of having allocated a virtual machine in a physical server by adding the maximum bandwidth information included in the bandwidth setting information regarding the network devices to the maximum bandwidth information of the virtual machine (calculating unit 16) (see FIG. 1). That is to say, the virtual machine management device 1 has a function to calculate total maximum bandwidth information of network devices in the event of having allocated a virtual machine in a physical server by adding the maximum bandwidth information of the virtual machine read out from the storage device to the maximum bandwidth information included in the QoS setting information read out from the storage device (calculating unit 16) (see FIG. 1).

Here, the maximum bandwidth information included in the QoS setting information corresponding to the first network device 21 is set for each time flame. Also, the maximum bandwidth information of the second virtual machine VM2 is set for each time flame. Therefore, the virtual machine management device 1 calculates total maximum bandwidth information of the first network device 21 in the event of having allocated the second virtual machine VM2 in the physical server 11 by adding the maximum bandwidth information of the second virtual machine VM2 to the maximum bandwidth information included in the QoS setting information corresponding to the first network device 21 for each time flame. Consequently, the virtual machine management device 1 has a function to calculate total maximum bandwidth information of network devices in the event of having allocated a virtual machine in a physical server by adding the maximum bandwidth information of the virtual machine to the maximum bandwidth information included in bandwidth setting information corresponding to the network devices for each time flame (calculating unit 16) (see FIG. 1).

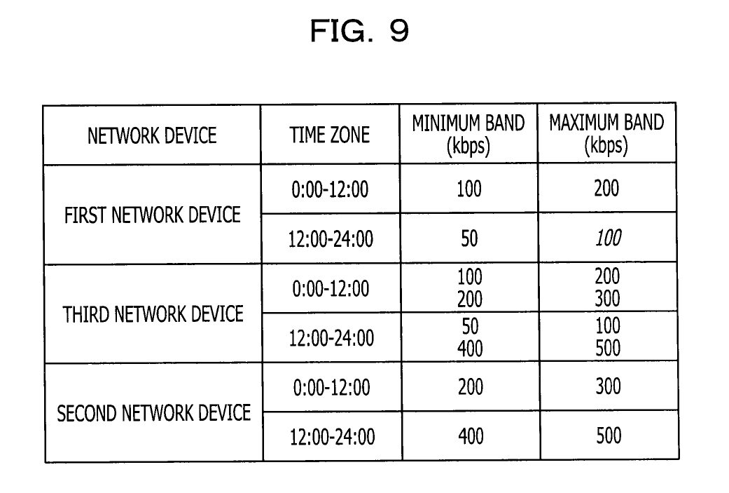

Note that, with the present embodiment, the storage device 706 includes a QoS setting information storage unit (QoS setting information database) 10C in which QoS setting information as to each of the network devices 21 to 23 is stored. Also, with the present embodiment, the first virtual machine VM1 and third virtual machine VM3 have already created, and at the time of creating these virtual machines VM1 and VM3, as illustrated in FIG. 9, the minimum bandwidth information and maximum bandwidth information for each time flame included in the QoS setting information corresponding to the first to third network devices 21 to 23 are stored in the QoS setting information storage unit 10C. That is to say, the minimum bandwidth information and maximum bandwidth information for each time flame included in the QoS setting information corresponding to the first network device 21 and second network device 22 existing on the route between the first physical server 11 decided as the allocation destination and the gateway 2 are stored in the QoS setting information storage unit 10C at the time of creation of the first virtual machine VM1. Also, the minimum bandwidth information and maximum bandwidth information for each time flame included in the QoS setting information corresponding to the third network device 23 and second network device 22 existing on the route between the second physical server 12 decided as the allocation destination and the gateway 2 are stored in the QoS setting information storage unit 10C at the time of creation of the third virtual machine VM3. Therefore, the storage device 706 is configured to store the minimum bandwidth information and maximum bandwidth information for each time flame included in the QoS setting information corresponding to the first to third network devices 21 to 23.

For example, values of 100 kbps and 200 kbps are stored in the storage device 706, i.e., the QoS setting information storage unit 10C as the minimum bandwidth information and maximum bandwidth information of a time flame of 0:00 to 12:00 included in the QoS setting information corresponding to the first network device 21, respectively. Also, values of 50 kbps and 100 kbps are stored as the minimum bandwidth information and maximum bandwidth information of a time flame of 12:00 to 24:00 included in the QoS setting information corresponding to the first network device 21 are stored, respectively. Also, values of 100 kbps and 200 kbps are stored as the minimum bandwidth information and maximum bandwidth information of a time flame of 0:00 to 12:00 included in the QoS setting information corresponding to the second network device 22 are stored for the first virtual machine VM1, respectively. Also, values of 50 kbps and 100 kbps are stored as the minimum bandwidth information and maximum bandwidth information of a time flame of 12:00 to 24:00 included in the QoS setting information corresponding to the second network device 22 are stored for the first virtual machine VM1, respectively. Also, values of 200 kbps and 300 kbps are stored as the minimum bandwidth information and maximum bandwidth information of a time flame of 0:00 to 12:00 included in the QoS setting information corresponding to the second network device 22 are stored for the third virtual machine VM3, respectively. Also, values of 400 kbps and 500 kbps are stored as the minimum bandwidth information and maximum bandwidth information of a time flame of 12:00 to 24:00 included in the QoS setting information corresponding to the second network device 22 are stored for the third virtual machine VM3, respectively. Also, values of 200 kbps and 300 kbps are stored as the minimum bandwidth information and maximum bandwidth information of a time flame of 0:00 to 12:00 included in the QoS setting information corresponding to the third network device 23 are stored, respectively. Also, values of 400 kbps and 500 kbps are stored as the minimum bandwidth information and maximum bandwidth information of a time flame of 12:00 to 24:00 included in the QoS setting information corresponding to the third network device 23 are stored, respectively.

Therefore, with the present embodiment, the virtual machine management device 1 calculates 400 kbps that is total maximum bandwidth information of a time flame of 0:00 to 12:00 of the first network device 21 in the event of having allocated the second virtual machine VM2 in the first physical server 11 by adding 200 kbps (see FIG. 6) that is the maximum bandwidth information of a time flame of 0:00 to 12:00 of the second virtual machine VM2 to 200 kbps (see FIG. 9) that is the maximum bandwidth information of a time flame of 0:00 to 12:00 corresponding to the first network device 21. Also, the virtual machine management device 1 calculates 400 kbps that is total maximum bandwidth information of a time flame of 12:00 to 24:00 of the first network device 21 in the event of having allocated the second virtual machine VM2 in the first physical server 11 by adding 300 kbps (see FIG. 6) that is the maximum bandwidth information of a time flame of 12:00 to 24:00 of the second virtual machine VM2 to 100 kbps (see FIG. 9) that is the maximum bandwidth information of a time flame of 12:00 to 24:00 corresponding to the first network device 21.

Similarly, the virtual machine management device 1 calculates total maximum bandwidth information of the second network device 22 in the event of having allocated the second virtual machine VM2 in the first physical server 11 based on the maximum bandwidth information included in the QoS setting information corresponding to the second network device 22, and the maximum bandwidth information of the second virtual machine VM2. For example, the virtual machine management device 1 reads out the maximum bandwidth information of the second virtual machine VM2 from the storage device 706, i.e., the SLA information storage unit 10B. Also, the virtual machine management device 1 reads out the maximum bandwidth information included in the QoS setting information corresponding to the second network device 22 from the storage device 706, i.e., the QoS setting information storage unit 10C. The virtual machine management device 1 calculates total maximum bandwidth information of the second network device 22 in the event of having allocated the second virtual machine VM2 in the first physical server 11 by adding the maximum bandwidth information of the second virtual machine VM2 to the maximum bandwidth information included in this QoS setting information.

Here, the maximum bandwidth information included in the QoS setting information corresponding to the second network device 22 is set for each time flame. Also, the maximum bandwidth information of the second virtual machine VM2 is set for each time flame. Therefore, the virtual machine management device 1 calculates total maximum bandwidth information of the second network device 22 in the event of having allocated the second virtual machine VM2 in the first physical server 11 by adding the maximum bandwidth information of the second virtual machine VM2 to the maximum bandwidth information included in the QoS setting information corresponding to the second network device 22 for each time flame.

For example, the virtual machine management device 1 calculates 700 kbps that is total maximum bandwidth information of a time flame of 0:00 to 12:00 of the second network device 22 in the event of having allocated the second virtual machine VM2 in the first physical server 11 by adding 200 kbps (see FIG. 6) that is the maximum bandwidth information of a time flame of 0:00 to 12:00 of the second virtual machine VM2 to 200 kbps and 300 kbps (see FIG. 9) that are the maximum bandwidth information of a time flame of 0:00 to 12:00 corresponding to the second network device 22. Also, the virtual machine management device 1 calculates 900 kbps that is total maximum bandwidth information of a time flame of 12:00 to 24:00 of the second network device 22 in the event of having allocated the second virtual machine VM2 in the first physical server 11 by adding 300 kbps (see FIG. 6) that is the maximum bandwidth information of a time flame of 12:00 to 24:00 of the second virtual machine VM2 to 100 kbps and 500 kbps (see FIG. 9) that are the maximum bandwidth information of a time flame of 12:00 to 24:00 corresponding to the second network device 22.

Next, as illustrated in FIG. 4, the virtual machine management device 1 determines whether there is a network device with insufficient capacity. For example, the virtual machine management device 1 determines whether the total maximum bandwidth information of the network devices 21 and 22 thus calculated is greater than the available maximum bandwidth information of each of the network devices 21 and 22 (step A40). Consequently, the virtual machine management device 1 has a function to determine whether total maximum bandwidth information is greater than available maximum bandwidth information (determining unit 17). This determining unit 17 is included in the above-mentioned deciding unit 15.

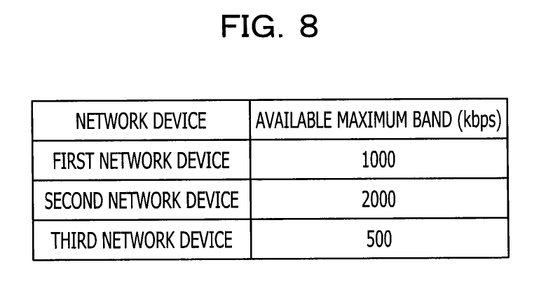

With the present embodiment, let us say that the available maximum bandwidth information of each of the network devices 21 to 23 existing within the management area 13 illustrated in FIG. 1 is stored in the storage device 706. For example, let us say that the available maximum bandwidth information of each of the network devices 21 to 23 existing within the management area 13 have been input, for example, by the system administrator beforehand, and the virtual machine management device 1 has performed processing to store the available maximum bandwidth information of each of the network devices 21 to 23 in the storage device 706. Consequently, the storage device 706 has an available maximum bandwidth information storage unit (available maximum bandwidth information database) 10D in which the available maximum bandwidth information of each of the network devices 21 to 23 is stored. Here, the available maximum bandwidth information of each of the network devices 21 to 23 is information representing the maximum bandwidth that each of the network devices 21 to 23 is allowed to process. For example, a value of 1000 kbps is, as illustrated in FIG. 8, stored in the storage device 706, i.e., the available maximum bandwidth information storage unit 10D as the available maximum bandwidth information of the first network device 21. Also, a value of 2000 kbps is stored as the available maximum bandwidth information of the second network device 22. Also, a value of 500 kbps is stored as the available maximum bandwidth information of the third network device 23. Note that the available maximum bandwidth information storage unit 10D will also be referred to as a capacity information storage unit.

Therefore, with the present embodiment, the virtual machine management device 1 reads out the available maximum bandwidth information of each of the network devices 21 and 22 from the storage device 706, i.e., the available maximum bandwidth information storage unit 10D, and determines whether the total maximum bandwidth information of the network devices 21 and 22 thus calculated is greater than the available maximum bandwidth information of each of the network devices 21 and 22. Consequently, the virtual machine management device 1 has a function to determine whether total maximum bandwidth information calculated by the calculating unit 16 is greater than available maximum bandwidth information read out from the storage device 706 (determining unit 17).

As a result of this determination, in the event of having determined that the total maximum bandwidth information of the network devices is greater than the available maximum bandwidth information of each of the network devices, the virtual machine management device 1 proceeds to a YES route, and the physical server serving as the allocation destination candidate is deleted from the allocation destination candidate list (step A50). On the other hand, in the event of having determined that the total maximum bandwidth information of the network devices is not greater than the available maximum bandwidth information of each of the network devices, the virtual machine management device 1 proceeds to a NO route, and the repeat processing is ended (step A60).

Here, the total maximum bandwidth information of the network devices 21 and 22 is calculated for each time flamed, and accordingly, the virtual machine management device 1 determines whether the total maximum bandwidth information of the network devices 21 and 22 is greater than the available maximum bandwidth information of each of the network devices 21 and 22 for each time flame. Consequently, the virtual machine management device 1 has a function to determine whether the total maximum bandwidth information is greater than the available maximum bandwidth information for each time flame (determining unit 17). In the event that determination is made that the total maximum bandwidth information of the network devices 21 and 22 is greater than the available maximum bandwidth information of each of the network devices 21 and 22 within any time flame, the virtual machine management device 1 proceeds to the YES route, and deletes the physical server serving as the allocation destination candidate from the allocation destination candidate list. On the other hand, in the event that determination is made that the total maximum bandwidth information of the network devices 21 and 22 is not greater than the available maximum bandwidth information of each of the network devices 21 and 22 within all of the time flames, the virtual machine management device 1 proceeds to the NO route, and ends the repeat processing (step A60).

For example, determination is made whether 400 kbps that is the total maximum bandwidth information of a time flame of 0:00 to 12:00 of the first network device 21 is greater than 1000 kbps that is the available maximum bandwidth information of the first network device 21. Also, determination is made whether 400 kbps that is the total maximum bandwidth information of a time flame of 12:00 to 24:00 of the first network device 21 is greater than 1000 kbps that is the available maximum bandwidth information of the first network device 21. Similarly, determination is made whether 700 kbps that is the total maximum bandwidth information of a time flame of 0:00 to 12:00 of the second network device 22 is greater than 2000 kbps that is the available maximum bandwidth information of the second network device 22. Also, determination is made whether 900 kbps that is the total maximum bandwidth information of a time flame of 12:00 to 24:00 of the second network device 22 is greater than 2000 kbps that is the available maximum bandwidth information of the second network device 22.

As a result of these determinations, with all of the time flames, determination is made that the total maximum bandwidth information of the first network device 21 is not greater than the available maximum bandwidth information of the first network device 21, and also, determination is made that the total maximum bandwidth information of the second network device 22 is not greater than the available maximum bandwidth information of the second network device 22. Consequently, the virtual machine management device 1 proceeds to the NO route, and ends the repeat processing without deleting the first physical server 11 from the allocation destination candidate list (step A60).

Next, the virtual machine management device 1 selects the second physical server 12 (VM host 2) included in the allocation destination candidate list (h=VM host 2), and starts the repeat processing, i.e., the processing in steps A10 to A60 in FIG. 4 (step A10).

For example, first, the virtual machine management device 1 obtains, in the event of having allocated a virtual machine (here, the second virtual machine VM2; VM guest) in the second physical server 12, network device information existing on the route with the gateway 2 (step A20).

With the present embodiment, the virtual machine management device 1 references the table stored in the storage device 706 to obtain the third network device 23 and second network device 22 as network device information existing on the route with the gateway 2 in the event of having allocated the second virtual machine VM2 in the second physical server 12.

Next, the virtual machine management device 1 calculates the total maximum bandwidth information of the third network device 23 and second network device 22 in the event of having allocated a virtual machine (here, the second virtual machine VM2; VM guest) in the second physical server 12 (step A30).

With the present embodiment, the virtual machine management device 1 calculates the total maximum bandwidth information of the third network device 23 in the event of having allocated the second virtual machine VM2 in the second physical server 12 based on the maximum bandwidth information included in the QoS setting information corresponding to the third network device 23, and the maximum bandwidth information of the second virtual machine VM2. For example, the virtual machine management device 1 reads out the maximum bandwidth information of the second virtual machine VM2 from the SLA information storage unit 10B. Also, the virtual machine management device 1 reads out the maximum bandwidth information included in the QoS setting information corresponding to the third network device 23 from the storage device 706, i.e., the QoS setting information storage unit 10C. The virtual machine management device 1 then calculates the total maximum bandwidth information of the third network device 23 in the event of having allocated the second virtual machine VM2 in the second physical server 12 by adding the maximum bandwidth information of the second virtual machine VM2 to the maximum bandwidth information included in this QoS setting information.

Here, the maximum bandwidth information included in the QoS setting information corresponding to the third network device 23 has been set for each time flame. Also, the maximum bandwidth information of the second virtual machine VM2 has been set for each time flame. Therefore, the virtual machine management device 1 calculates the total maximum bandwidth information of the third network device 23 in the event of having allocated the second virtual machine VM2 in the second physical server 12 by adding the maximum bandwidth information of the second virtual machine VM2 to the maximum bandwidth information included in the QoS setting information corresponding to the third network device 23 for each time flame.

For example, the virtual machine management device 1 calculates 500 kbps that is total maximum bandwidth information of a time flame of 0:00 to 12:00 of the third network device 23 in the event of having allocated the second virtual machine VM2 in the second physical server 12 by adding 200 kbps (see FIG. 6) that is the maximum bandwidth information of a time flame of 0:00 to 12:00 of the second virtual machine VM2 to 300 kbps (see FIG. 9) that is the maximum bandwidth information of a time flame of 0:00 to 12:00 corresponding to the third network device 23. Also, the virtual machine management device 1 calculates 800 kbps that is total maximum bandwidth information of a time flame of 12:00 to 24:00 of the third network device 23 in the event of having allocated the second virtual machine VM2 in the second physical server 12 by adding 300 kbps (see FIG. 6) that is the maximum bandwidth information of a time flame of 12:00 to 24:00 of the second virtual machine VM2 to 500 kbps (see FIG. 9) that is the maximum bandwidth information of a time flame of 12:00 to 24:00 corresponding to the third network device 23.

Similarly, the virtual machine management device 1 calculates the total maximum bandwidth information of the second network device 22 in the event of having allocated the second virtual machine VM2 in the second physical server 12 based on the maximum bandwidth information included in the QoS setting information corresponding to the second network device 22, and the maximum bandwidth information of the second virtual machine VM2. For example, the virtual machine management device 1 reads out the maximum bandwidth information of the second virtual machine VM2 from the storage device 706, i.e., the SLA information storage unit 10B. Also, the virtual machine management device 1 reads out the maximum bandwidth information included in the QoS setting information corresponding to the second network device 22 from the QoS setting information storage unit 10C. The virtual machine management device 1 calculates the total maximum bandwidth information of the second network device 22 in the event of having allocated the second virtual machine VM2 in the second physical server 12 by adding the maximum bandwidth information of the second virtual machine VM2 to the maximum bandwidth information included in this QoS setting information.

Here, the maximum bandwidth information included in the QoS setting information corresponding to the second network device 22 has been set for each time flame. Also, the maximum bandwidth information of the second virtual machine VM2 has been set for each time flame. Therefore, the virtual machine management device 1 calculates the total maximum bandwidth information of the second network device 22 in the event of having allocated the second virtual machine VM2 in the second physical server 12 by adding the maximum bandwidth information of the second virtual machine VM2 to the maximum bandwidth information included in the QoS setting information corresponding to the second network device 22 for each time flame.

For example, the virtual machine management device 1 calculates 700 kbps that is total maximum bandwidth information of a time flame of 0:00 to 12:00 of the second network device 22 in the event of having allocated the second virtual machine VM2 in the second physical server 12 by adding 200 kbps (see FIG. 6) that is the maximum bandwidth information of a time flame of 0:00 to 12:00 of the second virtual machine VM2 to 200 kbps and 300 kbps (see FIG. 9) that are the maximum bandwidth information of a time flame of 0:00 to 12:00 corresponding to the second network device 22. Also, the virtual machine management device 1 calculates 900 kbps that is total maximum bandwidth information of a time flame of 12:00 to 24:00 of the second network device 22 in the event of having allocated the second virtual machine VM2 in the second physical server 12 by adding 300 kbps (see FIG. 6) that is the maximum bandwidth information of a time flame of 12:00 to 24:00 of the second virtual machine VM2 to 100 kbps and 500 kbps (see FIG. 9) that are the maximum bandwidth information of a time flame of 12:00 to 24:00 corresponding to the second network device 22.

Next, the virtual machine management device 1 determines whether there is a network device with insufficient capacity. For example, the virtual machine management device 1 determines whether the total maximum bandwidth information of the network devices 22 and 23 thus calculated is greater than the available maximum bandwidth information of each of the network devices 22 and 23 (step A40).

Here, as described above, the total maximum bandwidth information of the network devices 22 and 23 is calculated for each time flame, and accordingly, the virtual machine management device 1 determines whether the total maximum bandwidth information of the network devices 22 and 23 thus calculated is greater than the available maximum bandwidth information of each of the network devices 22 and 23 for each time flame. In the event that determination is made that the total maximum bandwidth information of the network devices 22 and 23 thus calculated is greater than the available maximum bandwidth information of each of the network devices 22 and 23 within any time flame, the virtual machine management device 1 proceeds to the YES route, and deletes the physical server serving as the allocation destination candidate from the allocation destination candidate list. On the other hand, with all of the time flames, in the event that determination is made that the total maximum bandwidth information of the network devices 22 and 23 thus calculated is not greater than the available maximum bandwidth information of each of the network devices 22 and 23, the virtual machine management device 1 proceeds to the NO route, and ends the repeat processing (step A60).

For example, determination is made whether 500 kbps that is the total maximum bandwidth information of a time flame of 0:00 to 12:00 of the third network device 23 is greater than 500 kbps that is the available maximum bandwidth information of the third network device 23. Also, determination is made whether 800 kbps that is the total maximum bandwidth information of a time flame of 12:00 to 24:00 of the third network device 23 is greater than 500 kbps that is the available maximum bandwidth information of the third network device 23. Similarly, determination is made whether 700 kbps that is the total maximum bandwidth information of a time flame of 0:00 to 12:00 of the second network device 22 is greater than 200 kbps that is the available maximum bandwidth information of the second network device 22. Also, determination is made whether 900 kbps that is the total maximum bandwidth information of a time flame of 12:00 to 24:00 of the second network device 22 is greater than 2000 kbps that is the available maximum bandwidth information of the second network device 22.

As s result of these determinations, with one time flame, determination is made that the total maximum bandwidth information of the third network device 23 is greater than the available maximum bandwidth information of the third network device 23. Accordingly, the virtual machine management device 1 proceeds to the YES route, deletes the physical server 12 from the allocation destination candidate list (step A50), and ends the repeat processing (step A60).

With the present embodiment, physical servers included in the allocation destination candidate list are only the first physical server 11 and second physical server 12, and accordingly, there is ended the processing for narrowing down physical servers serving as allocation destination candidates out of the allocation destination candidate list based on the network bandwidth information by performing the above-mentioned repeat processing.

In this manner, physical servers (VM hosts) serving as allocation destination candidates are narrowed down out of the allocation destination candidate list based on the network bandwidth information. With the present embodiment, of the allocation destination candidate list, the physical servers serving as allocation destination candidates are narrowed down to the first physical server 11 by the second physical server 12 being deleted therefrom.

Next, as illustrated in FIG. 3, the virtual machine management device 1 narrows down the physical servers (VM hosts) serving as allocation destination candidates out of the allocation destination candidate list based on the hardware resource information of the physical servers (step S50).

Here, the virtual machine management device 1 reads out hardware resource information such as the CPU, memory, HDD, and so forth of a virtual machine (here, the second virtual machine VM2) to be newly allocated, from the storage device 706, i.e., the virtual machine resource information storage unit 10A. Here, examples of the hardware resource information such as the CPU, memory, HDD, and so forth include the number of CPUs, CPU performance, a memory size, and a storage size. The virtual machine management device 1 compares the hardware resource information of the second virtual machine VM2, and the hardware resource information of each physical server within the allocation destination candidate list, and determines whether there is a physical server with any hardware having insufficient capacity. As a result of this determination, in the event that determination is made that there is a physical server with any hardware having insufficient capacity, the physical server thereof is deleted from the allocation destination candidates list. On the other hand, determination is made that there is no physical server with any hardware having insufficient capacity, the allocation destination candidate list is unchanged. In this manner, physical servers serving as allocation destination candidates are narrowed down out of the allocation destination candidate list.

With the present embodiment, by the above-mentioned processing in step S40, i.e., the narrowing down processing based on the network bandwidth information, of the allocation destination candidate list, the second physical server 12 is deleted, and is narrowed down to the first physical server 11. Therefore, with the processing in step S50, i.e., the narrowing down processing based on the hardware resource information of the physical servers, the hardware resource information of the first physical server 11, and the hardware resource information of the second virtual machine VM2, which are remaining in the allocation destination candidate list, are compared, and determination is made which is a physical server with any hardware having insufficient capacity. As a result of this determination, the first physical server 11 is determined not to be a physical server with any hardware having insufficient capacity, i.e., determination is made that there is no physical server with any hardware having insufficient capacity in the allocation destination candidate list, and the allocation destination candidate list is unchanged.

Next, as a result of the physical servers (VM hosts) serving as allocation destination candidates being narrowed down from the allocation destination candidate list in steps S40 and S50, the virtual machine management device 1 determines whether there is a physical server serving as an allocation destination candidate in the allocation destination candidate list (step S60). In other words, the virtual machine management device 1 determines whether there is a VM host serving as a VM guest creation destination in the VM host creation destination candidate list.

As a result of this determination, in the event that determination is made that there is a physical server serving as an allocation destination candidate in the allocation destination candidate list, the virtual machine management device 1 proceeds to a YES route, and selects one physical server (VM host) from the physical servers serving as allocation destination candidates based on a network device bandwidth use ratio or physical server hardware resource use ratio (step S70). Consequently, the virtual machine management device 1 has a function to select one physical server from the physical servers serving as allocation destination candidates based on the network device bandwidth use ratio or physical server hardware resource use ratio (selecting unit). This selecting unit is included in the above-mentioned deciding unit 15.

Note that, though an arrangement is made here wherein one physical server is selected from the physical servers serving as allocation destination candidates based on the network device bandwidth use ratio or physical server hardware resource use ratio, but the present technology is not restricted to this. For example, one physical server may randomly be selected out of the physical servers serving as allocation destination candidates. Also, for example, the allocation destination candidate list may be displayed on the display device of the terminal 7 or 8 of the system user or system administrator to prompt the system user or system administrator to select one physical server.

With the present embodiment, the first physical server 11 alone is included in the allocation destination candidate list, and accordingly, in step S60 determination is made that there is a physical server serving as an allocation destination candidate in the allocation destination candidate list, the virtual machine management device 1 proceeds to the YES route, and selects the first physical server 11 as a physical server serving as an allocation destination candidate.

In this manner, the virtual machine management device 1 decides a physical server serving as an allocation destination of a virtual machine out of the physical server allocation destination candidate list. For example, the virtual machine management device 1 decides a physical server serving as a virtual machine allocation destination, i.e., a VM host serving as a VM guest creation destination based on maximum bandwidth information included in the QoS setting information corresponding to a network device existing on a route between a physical server serving as an allocation destination candidate and the gateway, maximum bandwidth information of a virtual machine of which the allocation destination is to be decided, available maximum bandwidth information of the network device, and hardware resource information of the physical server. With the present embodiment, the physical server serving as the allocation destination of the second virtual machine VM2 to be newly allocated is decided as the first physical server 11 (VM host 1).

Next, the virtual machine management device 1 performs QoS setting instruction on a network device existing on a route between the physical server decided as the allocation destination and the gateway, and also instructs the physical server decided as the allocation destination creation of a virtual machine (steps S80 to S100). Note that the QoS setting instruction will also be referred to as bandwidth setting instruction.

For example, first, the virtual machine management device 1 performs QoS setting instruction on a network device existing on a route between the physical server decided as the allocation destination and the gateway (steps S80 and S90). Consequently, the virtual machine management device 1 has a function to manage bandwidth setting of a network device (bandwidth setting management unit). Also, the virtual machine management device 1 has a function to perform bandwidth setting instruction on a network device existing on a route between a physical server decided as the allocation destination and the gateway (bandwidth setting instruction unit; QoS setting instruction unit). This bandwidth setting instruction unit is included in the bandwidth setting management unit. Note that the bandwidth setting management unit is included in the QoS setting management unit 18.

Here, first, the virtual machine management device 1 updates the minimum bandwidth information and maximum bandwidth information for each time flame included in the QoS setting information corresponding to a network device existing on a route between the physical server decided as the allocation destination and the gateway, and stores this in the storage device 706, i.e., the QoS setting information storage unit 10C (step S80).

With the present embodiment, as described above, the physical server serving as the allocation destination of the second virtual machine VM2 to be newly allocated is decided as the first physical server 11 (VM host 1). In this case, network devices existing on the route between the first physical server and the gateway 2 are the first network device 21 and second network device 22. Therefore, the virtual machine management device 1 embeds the minimum bandwidth information and maximum bandwidth information included in the SLA information of the second virtual machine VM2 (see FIG. 6) in the minimum bandwidth information and maximum bandwidth information for each time flame included in the QoS setting information corresponding to the first network device 21 and second network device 22 (see FIG. 9), updates the minimum bandwidth information and maximum bandwidth information for each time flame included in the QoS setting information corresponding to the first network device 21 and second network device 22, and stores this in the storage device 706, i.e., the QoS setting information storage unit 10C.

For example, the virtual machine management device 1 reads out the minimum bandwidth information and maximum bandwidth information for each time flame included in the QoS setting information (see FIG. 9) corresponding to the first and second network devices 21 and 22 stored in the storage device 706, i.e., the QoS setting information storage unit 10C. Also, the virtual machine management device 1 reads out the minimum bandwidth information and maximum bandwidth information for each time flame included in the SLA information (see FIG. 6) of the second virtual machine VM2 stored in the storage device 706, i.e., the SLA information storage unit 10B. The virtual machine management device 1 embeds the minimum bandwidth information and maximum bandwidth information for each time flame included in the SLA information of the second virtual machine VM2 as the minimum bandwidth information and maximum bandwidth information for each time flame included in the QoS setting information corresponding to the first and second network devices 21 and 22 existing on the route between the first physical server 11 and the gateway 2, updates the minimum bandwidth information and maximum bandwidth information for each time flame included in the QoS setting information corresponding to the first and second network devices 21 and 22, and stores this in the storage device 706, i.e., the QoS setting information storage unit 10C.

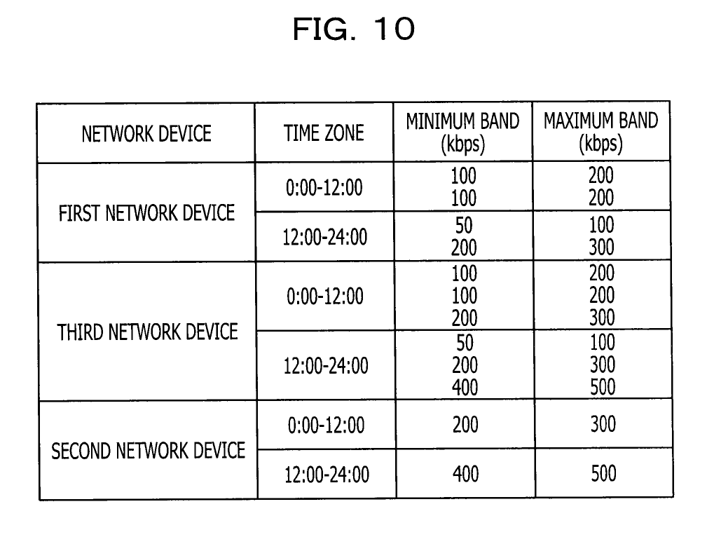

For example, as illustrated in FIG. 9, values of 100 kbps and 200 kbps have already been set for the first virtual machine VM1 as the minimum bandwidth information and maximum bandwidth information of a time flame of 0:00 to 12:00 included in the QoS setting information corresponding to the first network device 21, respectively. Also, values of 50 kbps and 100 kbps have already been set for the first virtual machine VM1 as the minimum bandwidth information and maximum bandwidth information of a time flame of 12:00 to 24:00 included in the QoS setting information corresponding to the first network device 21, respectively. As illustrated in FIG. 10, the virtual machine management device 1 embeds in these the minimum bandwidth information and maximum bandwidth information for each time flame included in the SLA information of the second virtual machine VM2, i.e., values of 100 kbps and 200 kbps that are the minimum bandwidth information and maximum bandwidth information of a time flame of 0:00 to 12:00, and values of 200 kbps and 300 kbps that area the minimum bandwidth information and maximum bandwidth information of a time flame of 12:00 to 24:00 (see FIG. 6), updates the QoS setting information for each time flame corresponding to the first network device 21, and stores this in the storage device 706, i.e., the QoS setting information storage unit 10C.

Thus, with the first network device 21, during a time flame of 0:00 to 12:00, the minimum bandwidth of 100 kbps and the maximum bandwidth of 200 kbps are secured for the first virtual machine VM1, and the minimum bandwidth of 100 kbps and the maximum bandwidth of 200 kbps are secured for the second virtual machine VM2. Also, with the first network device 21, during a time flame of 12:00 to 24:00, the minimum bandwidth of 50 kbps and the maximum bandwidth of 100 kbps are secured for the first virtual machine VM1, and the minimum bandwidth of 200 kbps and the maximum bandwidth of 300 kbps are secured for the second virtual machine VM2.

Similarly, as illustrated in FIG. 9, values of 100 kbps and 200 kbps have already been set for the first virtual machine VM1 as the minimum bandwidth information and maximum bandwidth information of a time flame of 0:00 to 12:00 included in the QoS setting information corresponding to the second network device 22, respectively. Also, values of 200 kbps and 300 kbps have already been set for the third virtual machine VM3 as the minimum bandwidth information and maximum bandwidth information of a time flame of 0:00 to 12:00 included in the QoS setting information corresponding to the second network device 22, respectively. Also, values of 50 kbps and 100 kbps have already been set for the first virtual machine VM1 as the minimum bandwidth information and maximum bandwidth information of a time flame of 12:00 to 24:00 included in the QoS setting information corresponding to the second network device 22, respectively. Also, values of 400 kbps and 500 kbps have already been set for the third virtual machine VM3 as the minimum bandwidth information and maximum bandwidth information of a time flame of 12:00 to 24:00 included in the QoS setting information corresponding to the second network device 22, respectively. As illustrated in FIG. 10, the virtual machine management device 1 embeds in these the minimum bandwidth information and maximum bandwidth information for each time flame included in the SLA information of the second virtual machine VM2, i.e., values of 100 kbps and 200 kbps that are the minimum bandwidth information and maximum bandwidth information of a time flame of 0:00 to 12:00, and values of 200 kbps and 300 kbps that area the minimum bandwidth information and maximum bandwidth information of a time flame of 12:00 to 24:00 (see FIG. 6), updates the QoS setting information for each time flame corresponding to the second network device 22, and stores this in the storage device 706, i.e., the QoS setting information storage unit 10C.

Thus, with the second network device 22, during a time flame of 0:00 to 12:00, the minimum bandwidth of 100 kbps and the maximum bandwidth of 200 kbps are secured for the first virtual machine VM1, the minimum bandwidth of 100 kbps and the maximum bandwidth of 200 kbps are secured for the second virtual machine VM2, and the minimum bandwidth of 200 kbps and the maximum bandwidth of 300 kbps are secured for the third virtual machine VM3. Also, with the second network device 22, during a time flame of 12:00 to 24:00, the minimum bandwidth of 50 kbps and the maximum bandwidth of 100 kbps are secured for the first virtual machine VM1, the minimum bandwidth of 200 kbps and the maximum bandwidth of 300 kbps are secured for the second virtual machine VM2, and the minimum bandwidth of 400 kbps and the maximum bandwidth of 500 kbps are secured for the third virtual machine VM3.

Next, as illustrated in FIG. 3, the virtual machine management device 1 performs bandwidth setting instruction (QoS setting instruction) on the network devices existing on the route between the physical server decided as the allocation destination and the gateway based on the minimum bandwidth information and maximum bandwidth information of the current time flame of the minimum bandwidth information and maximum bandwidth information for each time flame included in the QoS setting information corresponding the network devices existing on the route between the physical server decided as the allocation destination and the gateway (step S90). Consequently, the virtual machine management device 1 has a function to perform bandwidth setting instruction on a network device existing on a route between a physical server decided as the allocation destination and the gateway based on the bandwidth setting information of the bandwidth setting information for each time flame corresponding to a network device existing on the route between a physical server decided as the allocation destination and the gateway (bandwidth setting instruction unit; QoS setting instruction unit).

With the present embodiment, as described above, the physical server serving as the allocation destination of the second virtual machine VM2 to be newly allocated is decided as the first physical server 11 (VM host 1). In this case, the network devices existing on the route between the first physical server 11 and the gateway 2 are the first network device 21 and second network device 22. In the event of this processing having been performed at a time flame of 0:00 to 12:00 for example, the time flame of 0:00 to 12:00 becomes the current time flame. Also, in the event of this processing having been performed at a time flame of 12:00 to 24:00 for example, the time flame of 12:00 to 24:00 becomes the current time flame. Therefore, in the event that the time flame of 0:00 to 12:00 becomes the current time flame, the QoS setting instruction is performed on each of the first network device 21 and second network device 22 based on the QoS setting information including the minimum bandwidth information and maximum bandwidth information of the time flame of 0:00 to 12:00 set as described above. Also, in the event that the time flame of 12:00 to 24:00 becomes the current time flame, the QoS setting instruction is performed on each of the first network device 21 and second network device 22 based on the QoS setting information including the minimum bandwidth information and maximum bandwidth information of the time flame of 12:00 to 24:00 set as described above.

Next, the virtual machine management device 1 instructs the physical server decided as the allocation destination creation of a virtual machine (step S100). That is to say, the virtual machine management device 1 instructs the VM host decided as the creation destination to create a VM guest. Consequently, the virtual machine management device 1 has a function to instruct a physical server decided as the allocation destination at the deciding unit 15 creation of a virtual machine (instruction unit 19).

On the other hand, in the event that determination is made in step S60 that there is no physical server serving as an allocation destination candidate in the allocation destination candidate list, the virtual machine management device 1 proceeds to a NO route, and ends the processing without performing allocation of a virtual machine, i.e., creation of a VM guest. Note that, in this case, the hardware resource information or SLA information of the virtual machine to be newly allocated (here, the second virtual machine VM2) may be deleted from the storage device 706.

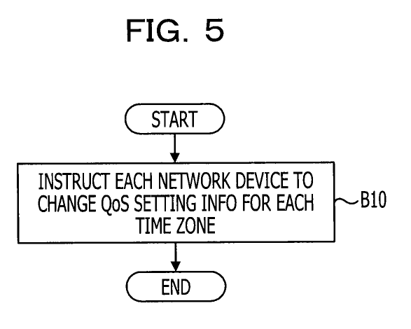

Thereafter, as illustrated in FIG. 5, the virtual machine management device 1 performs QoS setting change instruction on the network devices for each time flame based on the QoS setting information including the minimum bandwidth information and maximum bandwidth information for each time flame corresponding to the network devices (step B10). Consequently, the virtual machine management device 1 has a function to perform bandwidth setting change instruction on network devices for each time flame based on the bandwidth setting information for each time flame corresponding to network devices (bandwidth setting change instruction unit; QoS setting change instruction unit). This bandwidth setting change instruction unit is included in the bandwidth setting management unit (QoS setting management unit 18). Note that the QoS setting instruction will also be referred to as bandwidth setting change instruction.

With the present embodiment, at the time of changing from the time flame of 0:00 to 12:00 to the time flame of 12:00 to 24:00, the virtual machine management device 1 performs the QoS setting change instruction on each of the first to third network devices 21 to 23 based on the QoS setting information including the minimum bandwidth information and maximum bandwidth information of the time flame of 12:00 to 24:00 set as described above. Also, at the time of changing from the time flame of 12:00 to 24:00 to the time flame of 0:00 to 12:00, the virtual machine management device 1 performs the QoS setting change instruction on each of the first to third network devices 21 to 23 based on the QoS setting information including the minimum bandwidth information and maximum bandwidth information of the time flame of 0:00 to 12:00 set as described above.

In this manner, with the present virtual machine management device 1, the above-mentioned processes are executed by the CPU 701 executing the virtual machine management program, and thus, the functions of the present virtual machine management device 1 are realized. Consequently, the present virtual machine management device 1 includes, as illustrated in FIG. 1, the deciding unit (allocation destination deciding unit) 15, instruction unit 19, bandwidth setting management unit (QoS setting management unit) 18, available maximum bandwidth information storage unit 10D, SLA information storage unit 10B, QoS setting information storage unit 10C, route information storage unit 10E, and virtual machine resource information storage unit 10A. The deciding unit 15 includes the calculating unit 16 and determining unit 17.

Accordingly, according to the virtual machine management device, virtual machine management program, virtual machine management method, and network system according to the present embodiment, there is an advantage in that a physical server serving as an allocation destination of a virtual machine may be decided so as to effectively use a network bandwidth. Thus, network resources, i.e., network devices provided to a network may effectively utilized, and a network bandwidth may effectively be used.

Also, at the time of allocating a virtual machine, a physical server serving as an allocation destination of a virtual machine by considering a network bandwidth to be used for the virtual machine. Therefore, virtual machines are allocated in a scattered manner so as to secure a sufficient network bandwidth. Thus, the network may be suppressed from becoming unstable, and from having a disadvantage for responsiveness of service. In this manner, an allocation destination not to cause convergence on the network even when allocating a virtual machine is selected, and accordingly, the network is stabilized, and service may be provided in a stable manner. Thus, a bandwidth used for a system user may be secured. As a result thereof, stable service may be provided to a service user through the network using a virtual machine. That is to say, a request of a service provider (system user) who wants to provide stable service to a service user through the network using a virtual machine may be satisfied.

Also, QoS setting (QoS control) for a network device is also performed at the time of allocating a virtual machine, and accordingly, load on the system administrator may be reduced since the system administrator does not have to perform QoS setting of a network device. On the other hand, in the event of allocating a virtual machine based on only the hardware resource situation of each physical server, the system administrator manually has to perform QoS setting based on information of all of the virtual machines to be allocated, and accordingly, the system administrator has a greater load. In particular, with a network system where a virtual machine is dynamically created such as a cloud environment, practical use is difficult when the system administrator performing QoS setting each time a virtual machine is created. Also, a bandwidth to be used differs for each virtual machine, i.e., SLA information differs for each virtual machine, and accordingly, based on this, the load is not small for the system administrator performing QoS setting of network devices.

Also, QoS setting change instruction is performed on network devices for each time flame, and accordingly, QoS setting for network devices is dynamically changed for each time flame, and accordingly, a network bandwidth may effectively be used. Also, a bandwidth to be used for a system user may be secured.

For example, a time flame to be prioritized may differ for each virtual machine. That is to say, a network bandwidth to be used for each virtual machine may vary depending on time flames. In particular, with a cloud environment, there may be a case where there are virtual machines to be used by multiple service users, a time flame for the virtual machine being used differs for each service user, and in this case, a network bandwidth to be used for each virtual machine varies depending on time flames. For example, with the above-mentioned embodiment, the second virtual machine VM2 has to have the maximum bandwidth of 200 kbps at a time flame of 0:00 to 12:00, but the maximum bandwidth of 300 kbps at a time flame of 12:00 to 24:00. Nevertheless, if we say that the maximum bandwidth used for the second virtual machine VM2 is not decided at the SLA for each time flame, the maximum bandwidth of the second virtual machine VM2 is decided as 300 kbps regardless of time flames. In this case, with the first and second network devices 21 and 22, the maximum bandwidth of 300 kbps is secured for the second virtual machine VM2 regardless of time flames. That is to say, though it is desirable to secure the maximum bandwidth of 200 kbps at the time flame of 0:00 to 12:00, the maximum bandwidth of 300 kbps is consequently secured. Therefore, the first and second network devices 21 and 22 are not effectively utilized, and the network bandwidth is not effectively used. On the other hand, with the above-mentioned embodiment, the minimum bandwidth information and maximum bandwidth information are decided at the SLA for each time flame, and based on these, the minimum bandwidth information and maximum bandwidth information included in the QoS setting information of each network device are set for each time flame. Based on the QoS setting information including the minimum bandwidth information and maximum bandwidth information set for each time flame, QoS setting change instruction is performed on network devices for each time flame. Therefore, with the first and second network devices 21 and 22, the maximum bandwidth of 200 kbps used for the second virtual machine VM2 is secured at the time flame of 0:00 to 12:00, and the maximum bandwidth of 300 kbps used for the second virtual machine VM2 is secured at the time flame of 12:00 to 24:00. In this manner, the network bandwidths may effectively be used, and also the bandwidths to be used for a system user are also assured. Also, virtual machines which has to have a traffic bandwidth at the same time are allocated in a scattered manner, and accordingly, the network is stabilized, and service may be provided in a stable manner.

Note that the present technology is not restricted to the configuration described in the above-mentioned embodiment, and various modifications may be made without departing form the essence of the present technology.

For example, with the network system according to the above-mentioned embodiment, there may be employed technology such as FCoE (Fiber Channel over Ethernet (registered trademark)) or the like. For example, the virtual machines may access their disk images managed by a storage system to use them as their storage devices.

Also, for example, with the above-mentioned embodiment, though the virtual machine management device configured of one server has a function to manage virtual machines, and a function to manage network devices, the present technology is not restricted to this, and these functions may be realized by separate servers. For example, an arrangement may be made wherein a network device management device is provided separately from the virtual machine management device according to the above-mentioned embodiment, and this network device management device performs QoS setting instruction or QoS setting change instruction for network devices. In this case, with the processing in step S90 in FIG. 3, there may be performed processing to instruct the network device management device to perform QoS setting instruction on network devices instead of the processing to perform QoS setting instruction on network devices. Also, with the processing illustrated in FIG. 5, there may be performed processing to instruct the network device management device to perform QoS setting change instruction on network devices for each time flame instead of the processing to perform QoS setting change instruction on network devices for each time flame.

Also, for example, with the above-mentioned embodiment, though the virtual machine management device performs the processes illustrated in FIG. 3, the order of these processes is not restricted to this. For example, in the event of performing the processes illustrated in FIG. 3, the process in step S50 may be performed before the process in step S40. Also, in the event of performing the processes illustrated in FIG. 3, the process in step S100 may be performed before the process in step S80, for example.

Also, for example, with the above-mentioned embodiment, description has been made regarding a case where the present technology has been applied to processing to decide, at the time of allocating a new virtual machine (at the time of provisioning), an allocation destination of the virtual machine, as an example, but the present technology is not restricted to this. For example, the present technology may also be applied to processing to decide, at the time of migration to move a virtual machine allocated in one physical server to another physical server, a movement destination of the virtual machine. That is to say, examples of processing that the CPU in the virtual machine management device executes in accordance with the virtual machine management program read in the memory include processing to decide, at the time of allocation of a new virtual machine, an allocation destination of the virtual machine, and processing to decide, at the time of migration, a movement destination of a virtual machine.

Here, movement of a virtual machine at the time of migration is realized with deletion of the virtual machine from a physical server serving as the movement source, and allocation (creation) of the virtual machine corresponding to a physical server serving as the movement destination. Note that, accompanied with deletion of the virtual machine from the physical server serving as the movement source, deletion of bandwidth setting information for the virtual machine serving as the movement source from the bandwidth setting information (QoS setting information) of a network device existing on a route between the physical server serving as the movement source and the gateway is also performed. In response to this, bandwidth setting (QoS setting) of a network device existing on the route between the physical server serving as the movement source and the gateway is also changed. Also, accompanied with allocation of the virtual machine corresponding to the physical server serving the movement destination, setting of bandwidth setting information for the virtual machine serving as the movement destination is also performed as the bandwidth setting information (QoS setting information) corresponding to a network device existing on the route between the physical server serving as the movement destination and the gateway. In response to this, bandwidth setting (QoS setting) of a network device existing on the route between the physical server serving as the movement destination and the gateway is also changed.

In this case, allocation of the virtual machine as to the physical server serving as the movement destination is the same as allocation of the virtual machine at the time of provisioning. That is to say, movement of the virtual machine at the time of migration is allocation of the virtual machine at the time of provisioning to which only deletion of the virtual machine from the physical server serving as the movement source is added.

Therefore, the processing to decide, at the time of migration, a movement destination of a virtual machine may be realized by performing the same processing as the processing to decide, at the time of provisioning according to the above-mentioned embodiment, an allocation destination of a virtual machine, following which performing the processing to delete the virtual machine from the physical server serving as the movement source, performing processing to delete bandwidth setting information for the virtual machine serving as the movement source from the bandwidth setting information (QoS setting information) corresponding to a network device existing on the route between the physical server serving as the movement source and the gateway, and performing bandwidth setting instruction (QoS setting instruction) on a network device existing on the route between the physical server serving as the movement source and the gateway. Therefore, let us say that “allocation” of a virtual machine includes “movement” of a virtual machine. Also, “allocation destination” of a virtual machine includes “movement destination” of a virtual machine.

Note that a system user (or system administrator) has to access the virtual machine management device 1 via the network 6 using the terminal 8 (or 7) to instruct the virtual machine management device 1 execution of the virtual machine management program, i.e., execution of processing to move a virtual machine to another physical server (processing to move a VM guest to another VM host). Also, the hardware resource information and SLA information of the virtual machine of which the movement destination is to be decided have already stored in the storage device 706 of the virtual machine management device 1, and accordingly, the processing to prompt the system user (or system administrator) to input these information, and to store these in the storage device 706 (steps S10 and S20 in FIG. 3) may be omitted.

For example, with the processing to decide, at the time of the provisioning according to the above-mentioned embodiment, an allocation destination of a virtual machine, at the time of performing the processing to instruct the physical server decided as the allocation destination creation of a virtual machine (step S100 in FIG. 3), processing to instruct the physical server serving as the movement destination deletion of the virtual machine has to be performed.

Also, with the processing to decide an allocation destination of a virtual machine at the time of provisioning according to the above-mentioned embodiment, there has to be performed processing to narrow down physical servers (VM hosts) serving as allocation destination candidates out of the allocation destination candidate list based on the network bandwidth information, i.e., the processing in step S40 in FIG. 3, and for example, processing to delete bandwidth setting information for a virtual machine serving as the movement source from the bandwidth setting information (QoS setting information) corresponding to a network device existing on the route between the physical server serving as the movement source and the gateway before (QoS setting information updating processing) performing the processing illustrated in FIG. 4.

Also, with the processing to decide an allocation destination of a virtual machine at the time of provisioning according to the above-mentioned embodiment, at the time of performing bandwidth setting instruction (QoS setting instruction) on a network device existing on the route between the physical server decided as the movement destination and the gateway (step S90 in FIG. 3), bandwidth setting instruction (QoS setting instruction) has to be performed on a network device existing on the route between the physical server serving as the movement source and the gateway. That is to say, based on the bandwidth setting information (QoS setting information) corresponding to a network device existing on the route between the physical server serving as the movement source and the gateway, from which the bandwidth setting information (QoS setting information) for the virtual machine serving as the movement source has been deleted, the bandwidth setting instruction (QoS setting instruction) has to be performed on a network device existing on the route between the physical server serving as the movement source and the gateway.

Also, in the event that determination is made in step S60 in FIG. 3 that illustrates the processing according to the above-mentioned embodiment that there is no physical server serving as the allocation destination candidate in the allocation destination candidate list, the virtual machine management device ends the processing without performing movement of the virtual machine, and accordingly, the virtual machine management device performs processing to restore the bandwidth setting information (QoS setting information) corresponding to a network device existing on the route between the physical server serving as the movement source and the gateway. That is to say, the virtual machine management device performs processing to add bandwidth setting information for the virtual machine serving as the movement source to the bandwidth setting information (QoS setting information) corresponding to a network device existing on the route between the physical server serving as the movement source and the gateway.

Also, for example, with the above-mentioned embodiment and modification, the virtual machine management device is configured assuming that the virtual machine management program has been installed into the computer, but the virtual machine management program (virtual machine management program causing the computer to realize the function as described above) causing the computer to execute the processing according to the above-mentioned embodiment and modification may be provided in a state stored in a computer-readable recording medium.

Here, examples of the recording medium include something capable of storing a program, such as memory such as semiconductor memory or the like, magnetic disks, optical discs [e.g., CD (Compact Disc)-ROM, DVD (Digital Versatile Disk), Blu-ray Disc, etc.], and magneto-optical disks (MO). Note that magnetic disks, optical discs, and magneto-optical disks, and so forth will also be referred to as portable recording media.

In this case, the virtual machine management program is read out from a portable recording medium via the driving device, and the read virtual machine management program is installed into the storage device. Thus, the virtual machine management device and virtual machine management method described in the above-mentioned embodiment and modification are realized, and in the same way as with the above-mentioned embodiment and modification, the processes at the time of allocating a new virtual machine according to the above-mentioned embodiment, and the processes at the time of migration according to the above-mentioned modification are performed by the CPU reading out the virtual machine management program installed into the storage device onto the memory and executing this. Note that the computer may also read a program directly from the portable recording medium to execute processing in accordance with the program thereof.

Also, the virtual machine management program that causes the computer to execute the processing according to the above-mentioned embodiment and modification may be provided via a network serving a transmission medium (e.g., the Internet, communication line such as a public line, private line, etc.).

For example, the virtual machine management program that a program provider provides over another computer such as a server or the like may be installed into a storage device via a network and communication interface, for example, such as the Internet, a LAN, or the like. Thus, the virtual machine management device and virtual machine management method described in the above-mentioned embodiment and modification are realized, and in the same way as with the above-mentioned embodiment and modification, the processes at the time of allocating a new virtual machine according to the above-mentioned embodiment, and the processes at the time of migration of the above-mentioned modification are performed by the CPU reading out the virtual machine management program installed into the storage device onto the memory and executing this. Note that the computer may also successively execute processing in accordance with the received program each time a program is transferred from another computer, for example, such as a server or the like.

According to the above-mentioned virtual machine management device, virtual machine management program, virtual machine management method, and network system, there is an advantage in that a physical server where a virtual machine is allocated may be decided so as to effectively use a network bandwidth.

All examples and conditional language recited herein are intended for pedagogical purposes to aid the reader in understanding the invention and the concepts contributed by the inventor to furthering the art, and are to be construed as being without limitation to such for example recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A device comprising:
a memory which stores a program; and
a processor which executes, based on the program, a procedure comprising:
deciding, based on maximum bandwidth information included in bandwidth setting information corresponding to a network device existing on a route between a physical server serving as an allocation destination candidate of a virtual machine and a gateway, maximum bandwidth information of the virtual machine, available bandwidth information of the network device, and hardware resource information of the physical server; and
instructing a decided physical server to create the virtual machine.

2. The device according to claim 1,
wherein the procedure comprises:
calculating, in the event of deciding a physical server where the virtual machine is allocated, total maximum bandwidth information of the network device when allocating the virtual machine in the physical server by adding the maximum bandwidth information of the virtual machine to the maximum bandwidth information included in the bandwidth setting information corresponding to the network device, and
deciding whether the total maximum bandwidth information is greater than the available bandwidth information.

3. The device according to claim 2, wherein the maximum bandwidth information of the virtual machine is included in SLA (Service Level Agreement) information, and the bandwidth setting information corresponding to the network device is included in QoS (Quality of Service) setting information.

4. The device according to claim 1, wherein the maximum bandwidth information is set for each time flame, and the maximum bandwidth information of the virtual machine is set for time flame;
wherein the procedure comprises:
calculating, in the event of deciding a physical server where the virtual machine is allocated, total maximum bandwidth information of the network device when allocating the virtual machine in the physical server by adding the maximum bandwidth information of the virtual machine to the maximum bandwidth information included in the bandwidth setting information corresponding to the network device for each bandwidth zone, and
deciding whether the total maximum bandwidth information is greater than the available bandwidth information for each time flame.

5. The device according to claim 4,
wherein the procedure comprises:
performing bandwidth setting instruction to the network device existing on a route between the physical server and the gateway decided as the allocation destination based on bandwidth setting information of the current time flame of bandwidth setting information for each time flame corresponding to the network device existing on a route between the physical server and the gateway decided as the allocation destination where the virtual machine is allocated, and
performing bandwidth setting change instruction to the network device for each time flame based on the bandwidth setting information corresponding to the network device.

6. A computer-readable recording medium having stored therein a program for causing a device to execute a digital signature process comprising:
deciding, based on maximum bandwidth information included in bandwidth setting information corresponding to a network device existing on a route between a physical server serving as an allocation destination candidate of a virtual machine and a gateway, maximum bandwidth information of the virtual machine, available bandwidth information of the network device, and hardware resource information of the physical server; and
instructing a decided physical server to create the virtual machine.

7. The computer-readable recording medium according to claim 6,
wherein the digital signature process comprises:
calculating, in the event of deciding a physical server where the virtual machine is allocated, total maximum bandwidth information of the network device when allocating the virtual machine in the physical server by adding the maximum bandwidth information of the virtual machine to the maximum bandwidth information included in the bandwidth setting information corresponding to the network device, and
deciding whether the total maximum bandwidth information is greater than the available bandwidth information.

8. The computer-readable recording medium according to claim 7,
wherein the maximum bandwidth information of the virtual machine is included in SLA (Service Level Agreement) information, and the bandwidth setting information corresponding to the network device is included in QoS (Quality of Service) setting information.

9. The computer-readable recording medium according to claim 6,
wherein the maximum bandwidth information is set for each time flame, and the maximum bandwidth information of the virtual machine is set for time flame,
wherein the digital signature process comprises:
calculating, in the event of deciding a physical server where the virtual machine is allocated, total maximum bandwidth information of the network device when allocating the virtual machine in the physical server by adding the maximum bandwidth information of the virtual machine to the maximum bandwidth information included in the bandwidth setting information corresponding to the network device for each bandwidth zone, and
deciding whether the total maximum bandwidth information is greater than the available bandwidth information for each time flame.

10. The computer-readable recording medium according to claim 9,
wherein the digital signature process comprises:
performing bandwidth setting instruction to the network device existing on a route between the physical server and the gateway decided as the allocation destination based on bandwidth setting information of the current time flame of bandwidth setting information for each time flame corresponding to the network device existing on a route between the physical server and the gateway decided as the allocation destination where the virtual machine is allocated, and
performing bandwidth setting change instruction to the network device for each time flame based on the bandwidth setting information corresponding to the network device.

11. A method comprising:
deciding, based on maximum bandwidth information included in bandwidth setting information corresponding to a network device existing on a route between a physical server serving as an allocation destination candidate of a virtual machine and a gateway, maximum bandwidth information of the virtual machine, available bandwidth information of the network device, and hardware resource information of the physical server; and
instructing a decided physical server to create the virtual machine.

12. The method according to claim 11 comprising:
calculating, in the event of deciding a physical server where the virtual machine is allocated, total maximum bandwidth information of the network device when allocating the virtual machine in the physical server by adding the maximum bandwidth information of the virtual machine to the maximum bandwidth information included in the bandwidth setting information corresponding to the network device, and
deciding whether the total maximum bandwidth information is greater than the available bandwidth information.

13. The method according to claim 13,
wherein the maximum bandwidth information of the virtual machine is included in SLA (Service Level Agreement) information, and the bandwidth setting information corresponding to the network device is included in QoS (Quality of Service) setting information.

14. The method according to claim 11,
wherein the maximum bandwidth information is set for each time flame, and the maximum bandwidth information of the virtual machine is set for time flame;
wherein the method comprises:
calculating, in the event of deciding a physical server where the virtual machine is allocated, total maximum bandwidth information of the network device when allocating the virtual machine in the physical server by adding the maximum bandwidth information of the virtual machine to the maximum bandwidth information included in the bandwidth setting information corresponding to the network device for each bandwidth zone, and
deciding whether the total maximum bandwidth information is greater than the available bandwidth information for each time flame.

15. The method according to claim 14 comprising:
performing bandwidth setting instruction to the network device existing on a route between the physical server and the gateway decided as the allocation destination based on bandwidth setting information of the current time flame of bandwidth setting information for each time flame corresponding to the network device existing on a route between the physical server and the gateway decided as the allocation destination where the virtual machine is allocated, and
performing bandwidth setting change instruction to the network device for each time flame based on the bandwidth setting information corresponding to the network device.
